(19) United States
(12) Patent Application Publication
(10) Pub. No.: US 2011/0221764 A1
(43) Pub. Date: Sep. 15, 2011

(54) LAYING OUT AND CROPPING IMAGES IN PRE-DEFINED LAYOUTS

(75) Inventors: Adam Spencer Callens, Redmond, WA (US); James Thomas Marshall, Redmond, WA (US); David Nelson Norelius, Redmond, WA (US)

(73) Assignee: Microsoft Corporation, Redmond, WA (US)

(21) Appl. No.: 12/722,541

(22) Filed: Mar. 12, 2010

(51) Int. Cl. G09G 5/00

(52) U.S. Cl. 345/625; 345/619; 345/620

(57) ABSTRACT

A layout definition file is created that stores data defining image layouts. An application program provides a user interface for laying out images and associated text using the contents of a layout definition file. The user interface includes a canvas onto which a user may place one or more images and a layout gallery through which a user may select a pre-defined layout. The layout gallery includes selectable visual representations corresponding to the pre-defined layouts. When one of the visual representations is selected, the corresponding pre-defined layout is applied to images on the canvas. Alternatively, one of the visual representations may be selected to cause placeholders for images and text in the corresponding pre-defined layout to be placed on the canvas. Images and text can be added to the layout by using the placeholders. Mechanisms are also provided for cropping images for use in a pre-defined layout.

### BACKGROUND

Many types of desktop applications allow users to add images and associated text annotations to their documents. For instance, many word processing applications, spreadsheet applications, and presentation applications allow a user to insert one or more images into a document and to place text annotations in relation to the images. These applications, however, generally provide little or no design guidance on how the images and the associated text annotations should be laid out in relation to one another. Instead, most applications require users to manually lay out the images and the associated text annotations.

While a manual approach to laying out images and associated text annotations does provide great flexibility for highly skilled designers, most users do not possess the creative design skills necessary to create a professional-looking layout of images and associated text. As a result, many users end up creating layouts with images and associated text that look amateurish, include misaligned or inappropriately sized images, and possibly text annotations that are inappropriately located or sized for the layout of the related images. In many cases, manually generated layouts simply do not communicate the message desired by the user.

Some desktop applications do provide limited functionality for assisting a user in laying out multiple images on a page automatically using static templates. These types of applications do not, however, dynamically lay out images and do not provide any guidance for laying out text annotations that are associated with the images. Moreover, these types of applications generally force users to utilize the exact structure and design of the provided templates. Users may not be permitted to modify the layout provided by the templates through the rearrangement or addition of images or related text. This can be frustrating for a user attempting to create a layout that includes text annotations or more or fewer images than permitted by the template.

Previous mechanisms for laying out images may also improperly crop images for a particular layout. For instance, some previous solutions might stretch an image for use in a layout in a manner that changes the aspect ratio of the image. This can result in the inclusion of an unattractive image in a layout. This can be frustrating to a user, especially when using images for which a proper aspect ratio is important, such as images of people.

It is with respect to these considerations and others that the disclosure made herein is presented.

### SUMMARY

Technologies are described herein for dynamically arranging images and related text annotations and for cropping images. Through the utilization of the technologies and concepts presented herein, an application program can dynamically lay out images and associated text annotations using pre-defined layouts. Moreover, images utilized in a layout can be cropped in a manner that does not change the aspect ratio of the image. As a result, a user with virtually no creative design skills can create a professional-looking layout of images and associated text annotations using the concepts and technologies disclosed herein.

According to one aspect presented herein, one or more pre-defined layouts are created and data defining the pre-defined layouts is stored in a layout definition file. Each pre-defined layout specifies a layout for one or more images and associated text annotations. In particular, each pre-defined layout specifies how the images and any associated text annotations should be sized and positioned in relation to one another. For instance, a layout may specify the location and size of the images in the layout along with the location, size, and style of text associated with the images. The layout may also specify how the layout should be modified if additional images or text are added to the layout. The contents of the layout definition file may be utilized to dynamically lay out images and associated text, and to regenerate the layout following the addition of new content or the modification of the layout.

According to another aspect, an application program is described herein that is operative to utilize the contents of the layout definition file to dynamically lay out images and associated text. In one implementation, the application program provides a user interface for dynamically laying out the images and associated text. The user interface includes a canvas onto which a user may place one or more images. The user interface also includes a control through which a user may select a pre-defined layout to be applied to images placed on the canvas. In one implementation, the control is a layout gallery that is displayed adjacent to the canvas. The layout gallery includes selectable visual representations corresponding to each of the available pre-defined layouts. When one of the visual representations is selected, the corresponding pre-defined layout is dynamically applied to images on the canvas.

According to another aspect, a user may also create a layout of images and text by selecting a pre-defined layout prior to placing any images on the canvas. For instance, a user interface showing selectable visual representations corresponding to each of the available pre-defined layouts may be displayed. In response to receiving a user selection of one of the visual representations, selectable image and text placeholders may be placed on the canvas. The location of the image and text placeholders is defined by the pre-defined layout associated with the selected representation.

User interfaces are also provided for replacing the image placeholders with user-specified images. For instance, a user might select an image placeholder in order to request that the selected placeholder be replaced with an image. In response thereto, the user may be prompted to select an image. Once the image has been selected, the image placeholder is replaced with the selected image. The text placeholders may also be replaced with user-supplied text in a similar manner.

According to yet another aspect, images specified for use in a layout may be cropped in a manner that maintains the original aspect ratio of the image. In one embodiment, a percentage change for cropping the image is determined. The percentage change is the amount the image should be cropped expressed as a percentage of the size of a destination shape used to crop the image. Once the percentage change has been determined, two sides of the image that should be cropped are determined. Once the sides of the image to be cropped have been determined, the identified sides of the image are cropped by the determined percentage change. Once the image has been cropped, it may be displayed in a layout. Cropping may be performed in a non-destructive manner such that the image is not modified by the cropping operation.

It should be appreciated that the implementations described herein are applicable to any type of computer program that lays out images and associated text. For example, the concepts presented herein may be utilized in word processing application programs, spreadsheet application programs, presentation application programs, desktop publishing application programs, and other types of application programs. The above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 graphically illustrates the contents of a layout definition file and several pre-defined layouts defined therein that are presented in one implementation;

FIGS. 2-4 are screen diagrams showing aspects of a user interface provided by an application program capable of dynamically laying out images and associated text using pre-defined layouts in one embodiment presented herein;

FIG. 5 is a flow diagram showing an illustrative process for dynamically laying out images placed on a canvas using pre-defined layouts in one implementation described herein;

FIGS. 6-9 are screen diagrams showing aspects of another user interface provided by an application program capable of dynamically laying out images and associated text using pre-defined layouts in one embodiment presented herein;

FIG. 10 is a flow diagram showing an illustrative process for dynamically laying out images using pre-defined layouts in one implementation described herein;

FIG. 11 is a flow diagram showing an illustrative process provided herein for cropping an image for use in an image layout according to one embodiment presented herein;

FIGS. 12A-12D are image diagrams illustrating additional aspects of one process presented herein for cropping an image for use in a layout; and

FIG. 13 is a computer architecture diagram showing an illustrative computer hardware and software architecture for a computing system capable of implementing the embodiments presented herein.

### DETAILED DESCRIPTION

The following detailed description is directed to technologies for dynamically arranging images and associated text using pre-defined layouts and for cropping images. Through the use of the embodiments presented herein, an application program can provide an automated, dynamic arrangement of images and associated text using pre-defined layouts. Utilizing an application program that embodies the concepts and technologies presented herein, a user can easily generate a professional-looking layout of images and associated text annotations. Moreover, images specified for use in a layout may be cropped in a manner that maintains the original aspect ratio of the image.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for laying out images and associated text and for cropping images will be described.

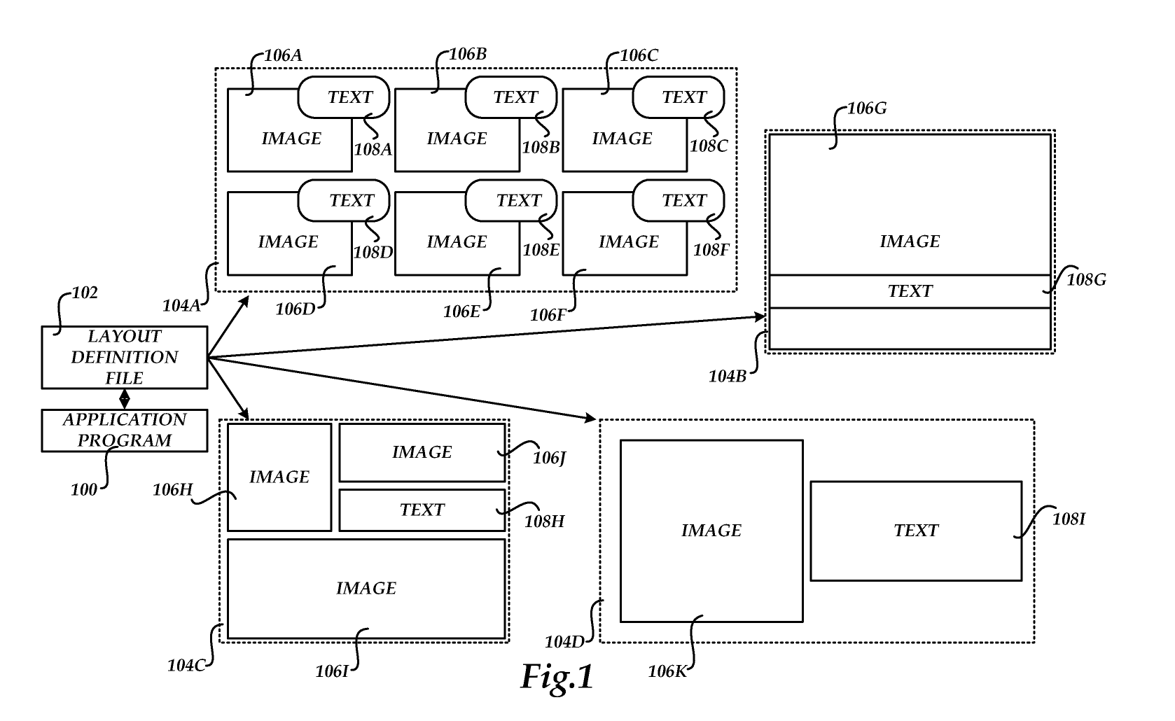

Turning now to FIG. 1, details will be provided regarding one embodiment presented herein for dynamically arranging images using pre-defined layouts. In particular, FIG. 1 illustrates aspects of an application program 100 and a layout definition file 102. The application program 100 utilizes the contents of the layout definition file 102 when dynamically laying out images and text. It should be appreciated that the application program 100 may be any type of application program that lays out images and associated text including, but not limited to, a word processing application program, a spreadsheet application program, a presentation creation application program, a web page design program, or a desktop publishing application program. The concepts presented herein are not limited to use with application programs for performing any particular function.

According to one implementation, the layout definition file 102 stores data that defines one or more layouts 104A-104D. The layouts 104A-104D each define the placement, size, and other characteristics for one or more images and, optionally, for text associated with the images. For instance, the layout 104A includes six images 106A-106D and text 108A-108D associated with the images. The layout 104B includes one image 106G and text 108G oriented horizontally across the image 106G. The layout 104C includes three images 106H-106J and text 108H placed between the images. The layout 104D includes one image 106K and text 108I. It should be appreciated that the layouts 104A-104D shown in FIG. 1 are merely illustrative and that the layout definition file 102 may define any number of layouts with any arrangement of images and/or associated text.

According to other aspects presented herein, the layout definition file 102 also stores data for use by the application program 100 in dynamically laying out the images and text within each layout. This data also allows the application program 100 to dynamically regenerate a layout following a modification to a layout, such as the rearrangement of the images or text in the layout or the addition of a new image or text to the layout. In one implementation, this data is stored as constraints and rules for dynamically generating each layout. The application program 100 utilizes the constraints and rules to lay out each of the images and text in a layout and to regenerate the layout following a modification.

Constraints define how a content object should be laid out by an application program. A content object may be an image, movie, text, or other type of digital media. The constraints may include data defining the position and size of each content object. The size and position of each object may be defined in relation to other objects or independently from other objects. The constraints also define how each content object should be formatted. For instance, the constraints for a text object may define the font face, font size, alignment, justification, and other formatting characteristics for the text. Constraints may include numeric values or Boolean values. Numeric constraints can specify a specific numeric value (e.g., width=1 inch). Numeric constraints may also define their value by referring to other constraints using references (e.g., height=width*0.75).

The application program 100 utilizes the rules defined in the layout definition file 102 to modify the constraints. In particular, the rules define how to modify one or more constraints to attempt to fit content within a layout. For instance, the application program 100 utilizes the rules to modify the constraints when application of the constraints to a content object results in the content overflowing specified boundaries for the content object. As an example, if an image is added to a layout that is too large for the layout, the image may be dynamically scaled, cropped, stretched, or otherwise resized to fit the layout. These operations may be performed in a non-destructive manner to preserve the contents of the image. In embodiments, some operations may be performed in a destructive manner. As another example, a constraint may specify that the font size for a text object is 14 points. In turn, the rules may specify that the font size may be reduced down to 8 points in an attempt to fit the text to the layout. It should be appreciated that rules and constraints may be propagated between different objects to ensure consistency in the layout. In this manner, for instance, all text or images in a layout may be made the same size. The application program 100 will dynamically adjust the size of the text or images depending upon the amount of text or number of images present in the layout.

According to other implementations, the layout definition file 102 may also specify a layout algorithm to be utilized by the application program 100 for laying out content. For instance, the layout definition file 102 may specify an algorithm for laying out text that is utilized by the application 100 to arrange the text within a layout. Other types of layout algorithms for other types of content objects may also be specified within the layout definition file 102. A user may also be permitted to add new layouts to the layout definition file 102.

According to one implementation, the contents of the layout definition file 102 are specified using the extensible markup language (“XML”). XML is a standard format for communicating data. In the XML data format, a schema is utilized to provide XML data with a set of grammatical and data type rules governing the types and structure of data that may be communicated. The XML data format is well known to those in the art and, therefore, not discussed in further detail herein. Additional details regarding the contents of the layout definition file 102 and one process utilized by the application program 100 for dynamically laying out images and text can be found in U.S. Patent Pub. No. US2006/0209093, filed on Mar. 15, 2005, and entitled “Method and Computer-Readable Medium for Generating Graphics Having a Finite Number of Dynamically Sized and Positioned Shapes,” U.S. Patent Pub. No. US006/0212801, filed on Mar. 15, 2006, and entitled “Method and Computer-Readable Medium for Fitting Text to Shapes Within a Graphic,” and U.S. Patent Pub. No. US 2006/0066631, filed on Sep. 30, 2004, and entitled “Method, System, and Computer-Readable Medium for Creating and Laying Out a Graphic Within an Application Program,” each of which is expressly incorporated herein by reference in its entirety.

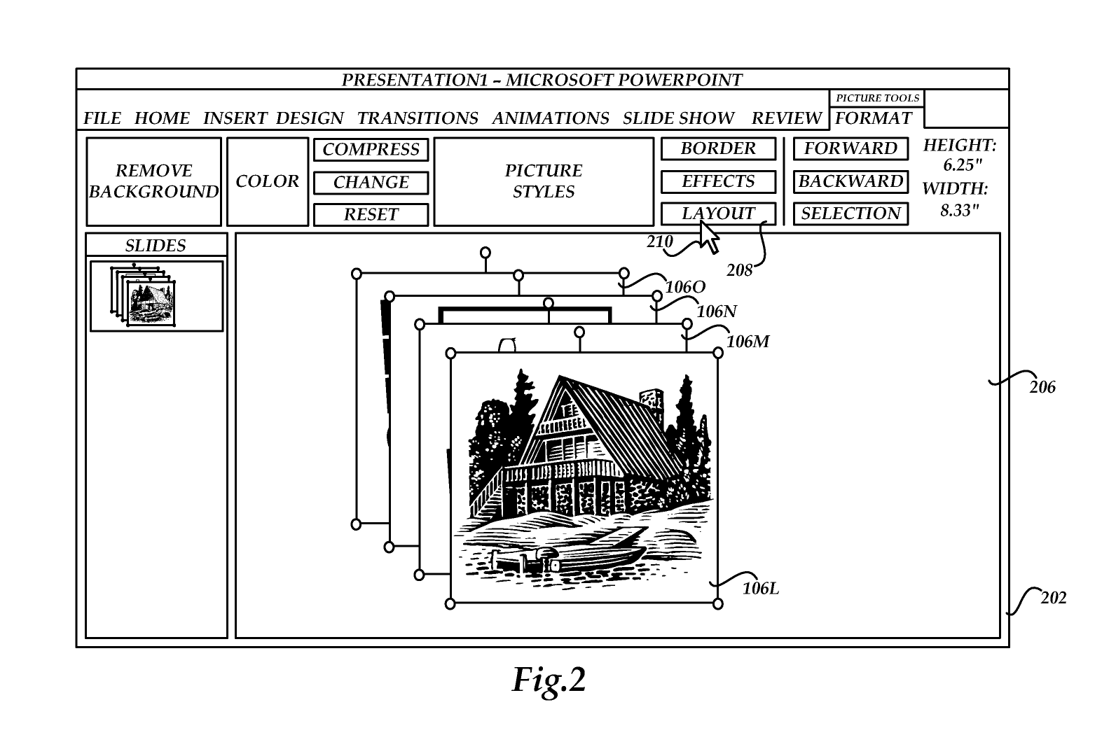

Referring now to FIG. 2, an illustrative user interface 202 provided by the application 100 in one embodiment for dynamically laying out images and associated text will be described. As shown in FIG. 2, the user interface 202 includes a canvas 206. The canvas 206 is utilized to hold the images and text for a layout. A user may place images on the canvas 206 through an appropriate operation, such as an insert operation or a “cut and paste” operation. For instance, in the example shown in FIG. 2, a user has placed the images 106L-106O on the canvas 206.

It should be appreciated that the canvas 206 may take different forms dependent on the nature of the application program 100. For instance, if the application 100 is a presentation application program, the canvas 206 may be a single slide within a slide presentation. If the application program 100 is a word processing application program 100, the canvas 206 may comprise a page within a word processing document. If the application program 100 is a spreadsheet application program, the canvas 206 may comprise a portion of a spreadsheet. The canvas 206 may take other forms when implemented by other types of application programs.

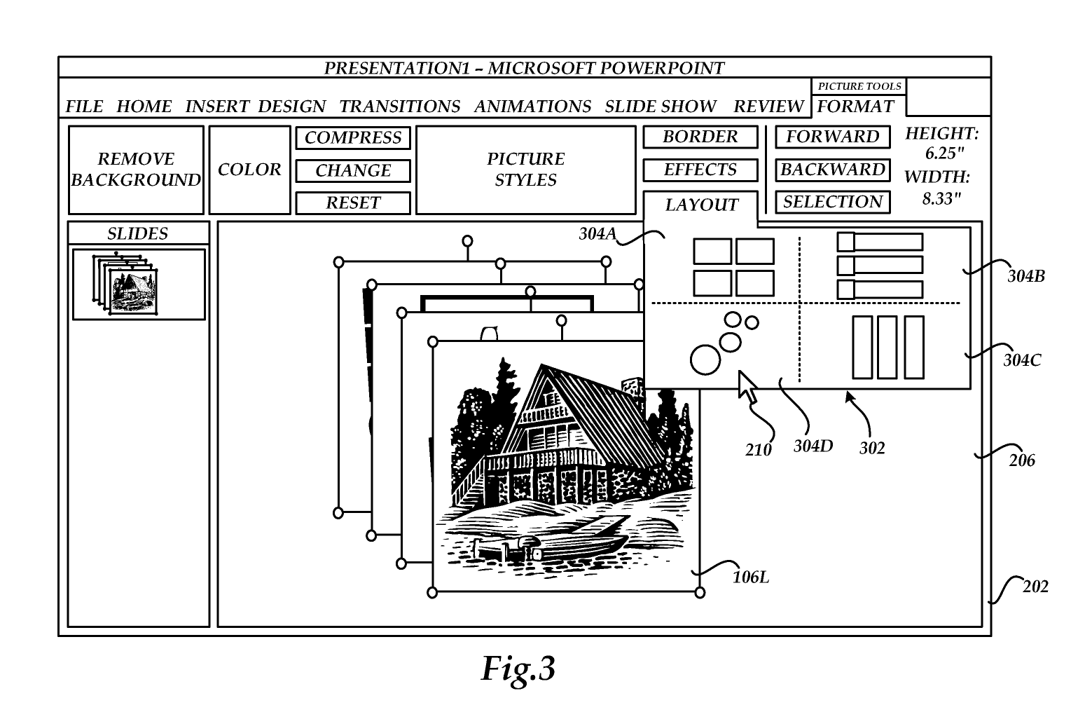

The user interface 202 shown in FIG. 2 also includes a user interface control 208 which, when selected, will cause a layout gallery to be displayed. The user interface control 208 shown in FIG. 2 is a button. However, other types of suitable user interface controls may be utilized. The user interface control 208 may be selected using a mouse input device and the mouse cursor 210 or another suitable user input device. In response to receiving a selection of the user interface control 208, the application program 110 displays the layout gallery 302 (shown in FIG. 3).

As illustrated in FIG. 3, the layout gallery 302 includes selectable visual representations 304A-304D of the pre-defined layouts that may be dynamically applied to images placed on the canvas 206. Each of the visual representations 304A-304D corresponds to a layout. For instance, the visual representation 304A corresponds to a layout having four images arranged in a symmetric pattern. The visual representation 304B corresponds to a layout having three images and text arranged horizontally. The visual representation 304C corresponds to a layout having three images arranged vertically. The visual representation 304D corresponds to a layout having four images cropped into circles and arranged in a bubble pattern. As will be described in greater detail below, when a visual representation is selected, such as by using the mouse cursor 210, the corresponding layout will be applied to the images and text that have been placed on the canvas 206 in one embodiment.

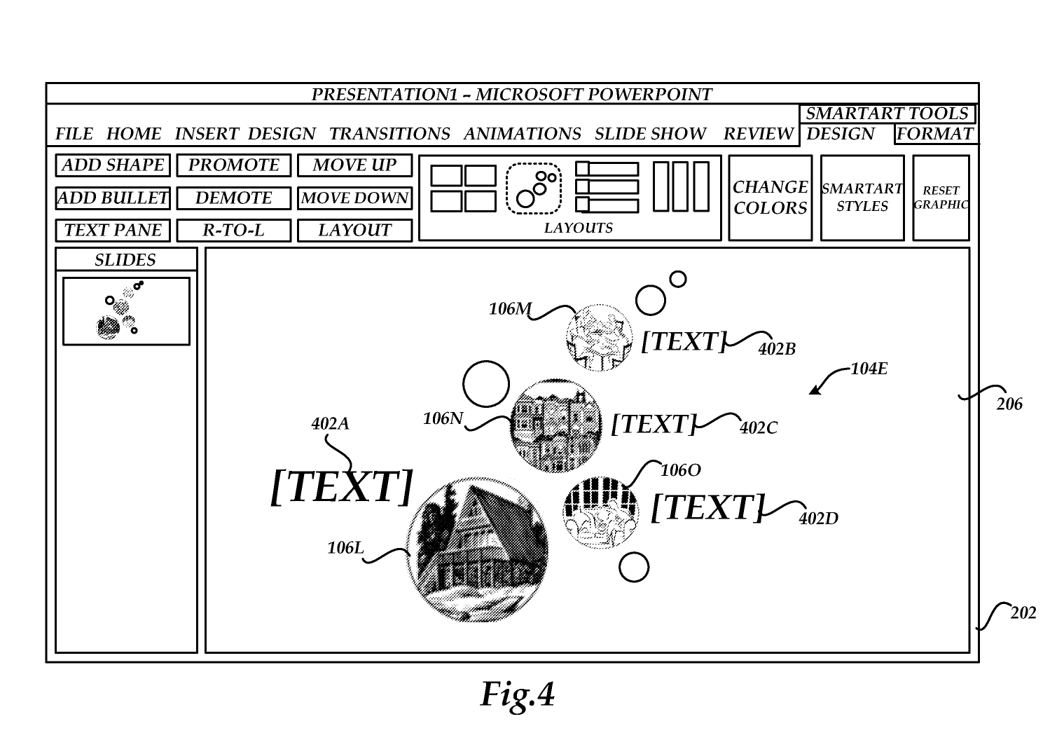

Referring now to FIG. 4, additional details regarding the operation of the user interface 202 provided in one embodiment will be described. In the example shown in FIG. 4, a user has utilized the mouse cursor 210 and a mouse button to select the visual representation 304D, shown in FIG. 3. As a result, a layout defined by the layout definition file 102 that corresponds to the visual representation 304D has been dynamically applied to the four images 106L-106O that were previously placed on the canvas 206 as shown in FIG. 2. This has resulted in the layout 104E shown on the canvas 206 in FIG. 4.

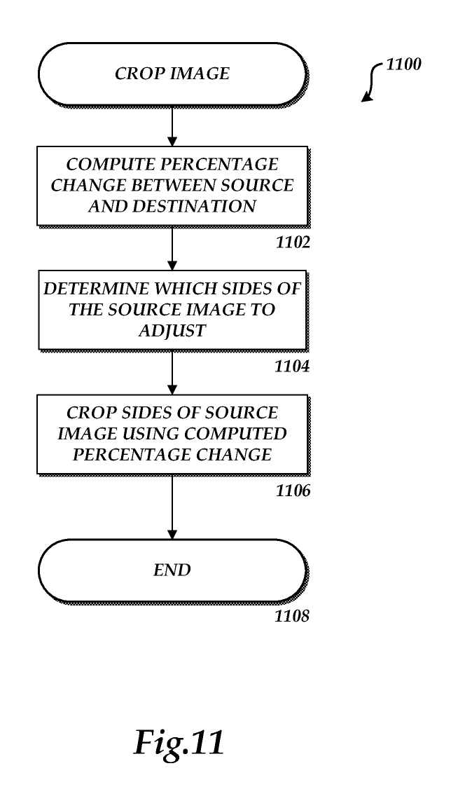

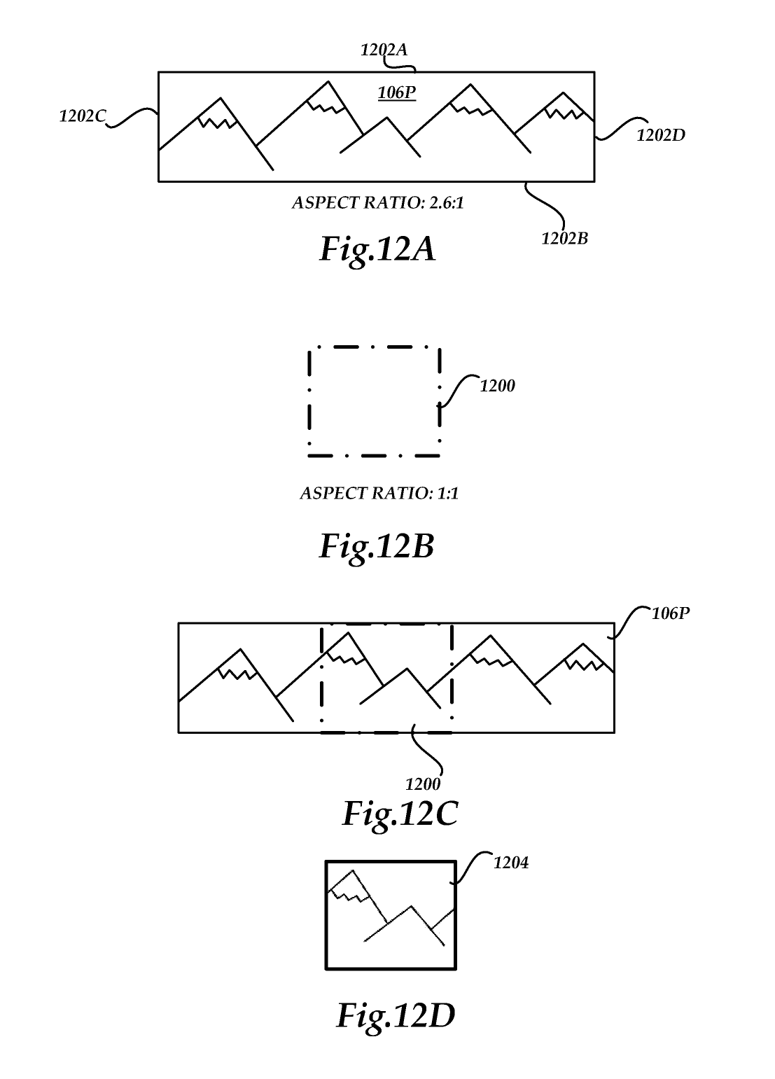

As shown in FIG. 4, the layout 104E includes the images 106L-106O and placeholder text 402A-402D associated with each of the images, respectively. In the example shown in FIG. 4, the images 106L-106O have been cropped for use in the layout 104E. In particular, in this example the images 106L-106O have been cropped into circles. It should be appreciated that the aspect ratio of the images 106L-106O has not been modified by the cropping operation. Additional details regarding one process presented herein for cropping images will be provided below with respect to FIGS. 11-12.

As described briefly above, the layout 104E includes placeholder text 402A-402D. The location, size, style, and other aspects of the placeholder text 402A-402D are also defined for the layout 104E by the layout definition file 102. It should be appreciated that a user may also modify the placeholder text 402A-402D by selecting the placeholder text 402A-402D and typing or pasting new text. The typed text will replace the placeholder text. Additional details regarding this process will be provided below.

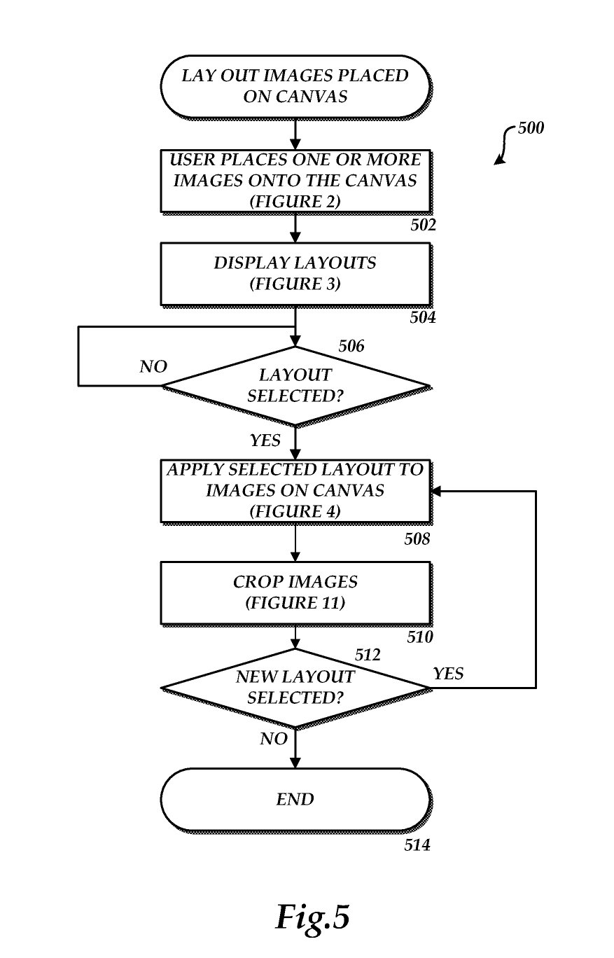

Turning now to FIG. 5, additional details will be provided regarding the embodiments presented herein for dynamically laying out images and associated text. In particular, FIG. 5 is a flow diagram showing a routine 500 that shows aspects of an illustrative process performed by the application program 100 for dynamically laying out images and associated text using pre-defined layouts in one embodiment wherein images 106 have been placed on the canvas 206.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 500 begins at operation 502, where a user places one or more images onto the canvas 206 as shown in FIG. 2. The routine 500 then continues to operation 504, where the application program 100 displays the available layouts, such as for instance in the layout gallery 302. From operation 504, the routine 500 continues to operation 506, where the application program 100 determines whether one of the visual representations 304A-304D in the layout gallery 302 has been selected, such as by the selection with the mouse cursor 210 and a corresponding mouse button click. If one of the visual representations 304A-304D has been selected, thereby indicating that the corresponding layout should be applied to the contents of the canvas 206, the routine 500 proceeds from operation 506 to operation 508.

At operation 508, the application program 100 dynamically applies the appropriate layout to the images and text on the canvas 206 in the manner described above with respect to FIG. 4. The routine 500 then continues to operation 510, where the images in the layout are cropped in a manner that retains the aspect ratio of the images. Details regarding one process presented herein for cropping images in this manner are provided below with respect to FIGS. 11 and 12.

From operation 510, the routine 500 proceeds to operation 512, where the application program 100 determines whether a new layout has been requested through the selection of one of the visual representations 304A-304D. If so, the routine 500 returns to operation 508, described above, where the application program 100 dynamically applies the appropriate layout to the contents of the canvas 206 in the manner described above with respect to FIG. 4. If a new layout has not been requested, the routine 500 continues from operation 512 to operation 512, where it ends. According to one embodiment, the cropping operation is not repeated following the selection of a new layout in order to preserve any changes to the cropping of images in the layout made by a user.

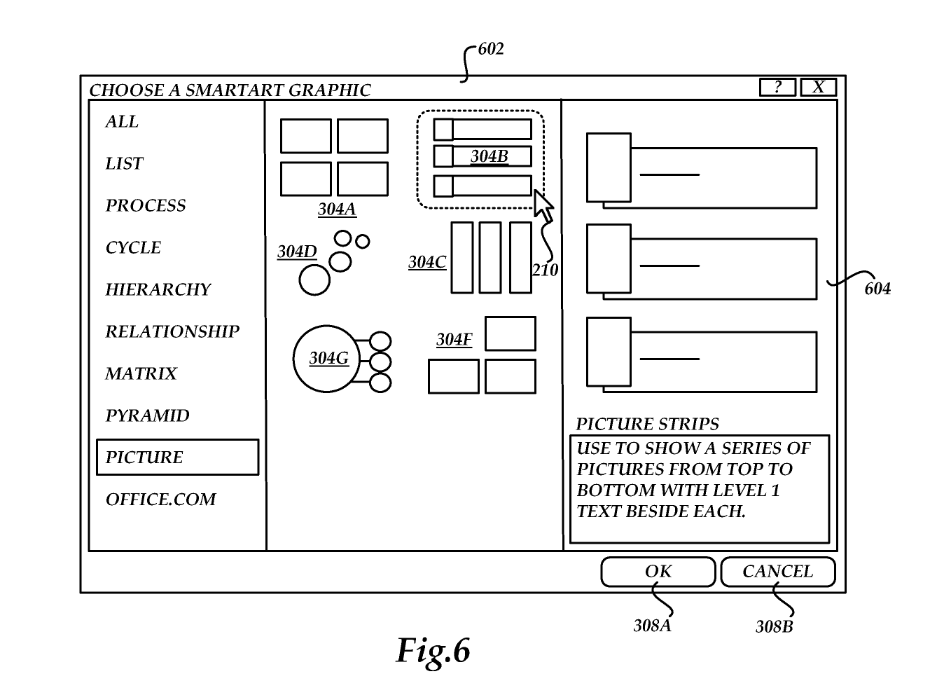

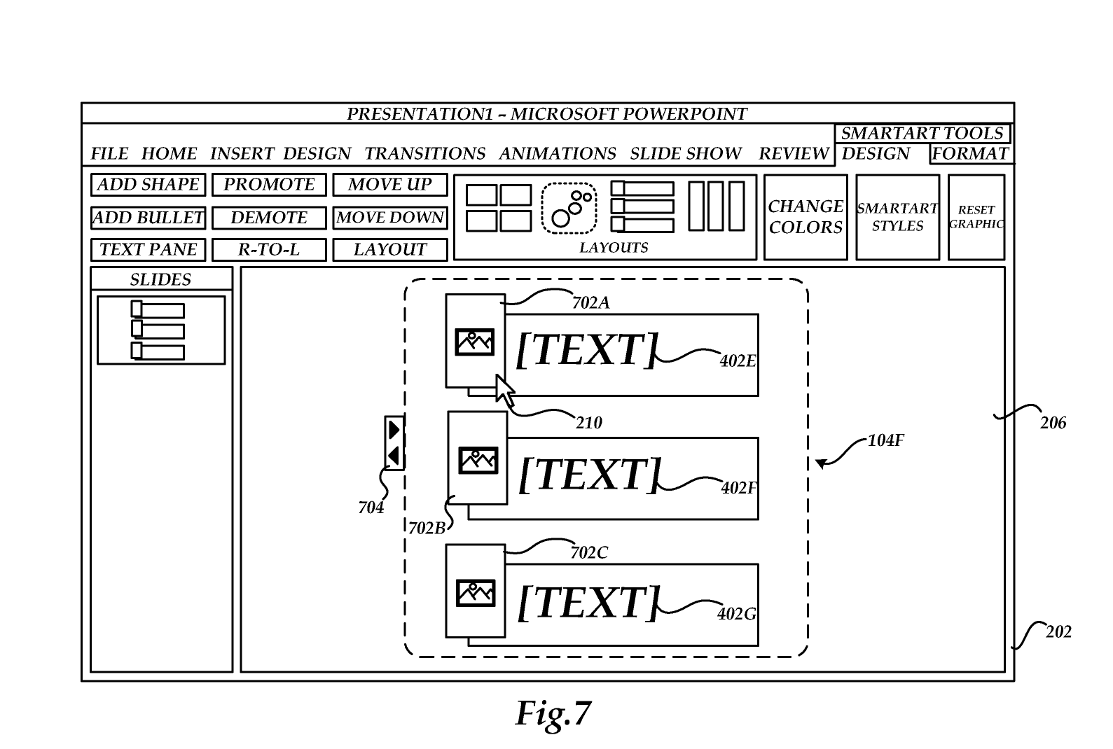

Turning now to FIG. 6, another user interface for creating a layout of images and associated text will be described. In particular, FIG. 6 shows an illustrative user interface 602 through which a user may specify a layout. In this embodiment, a layout is selected prior to placing any images 106 on the canvas 206. As will be described in greater detail below, once a layout has been selected, image and text placeholders are placed on the canvas 206 according to the selected layout. The image and text placeholders can then be utilized to place images and text, respectively, in the layout. Additional details regarding this process will be provided below with respect to FIGS. 7-10.

The user interface 602 shown in FIG. 6 may be displayed in response to a request from a user to create an image layout. An appropriate user interface control may be selected by a user to make such a request. The user interface 602 includes selectable visual representations 304A-304G of the pre-defined layouts that may be utilized. If a user interface pointer, such as the mouse cursor 210, is hovered over one of the representations 304A-304G, a preview of the selected representation will be displayed. For instance, in the example shown in FIG. 6, the mouse cursor 210 is hovering over the representation 304B, thereby causing the preview 604 of the corresponding layout to be displayed in the user interface 602. The user interface control 308A may then be selected to cause the layout corresponding to the visual representation 304B to be applied to the canvas 206. Alternately, the user interface control 308B may be selected to cancel the creation of the new layout.

In response to the selection of the user interface control 308A, the user interface 202 shown in FIG. 7 is displayed. In this example, a layout 104F has been created on the canvas 206 that corresponds to the visual representation 304B selected in FIG. 6. As shown in FIG. 7, the layout 104F includes image placeholders 702A-702C and text placeholders 402E-402G. The image placeholders 702A-702C are user interface controls that hold the place of images within the layout 104F. The image placeholders 702A-702C may be selected, such as by the use of the mouse cursor 210. In response to selecting one of the image placeholders 702A-702C, a user may be prompted to select an image to replace the selected image placeholder.

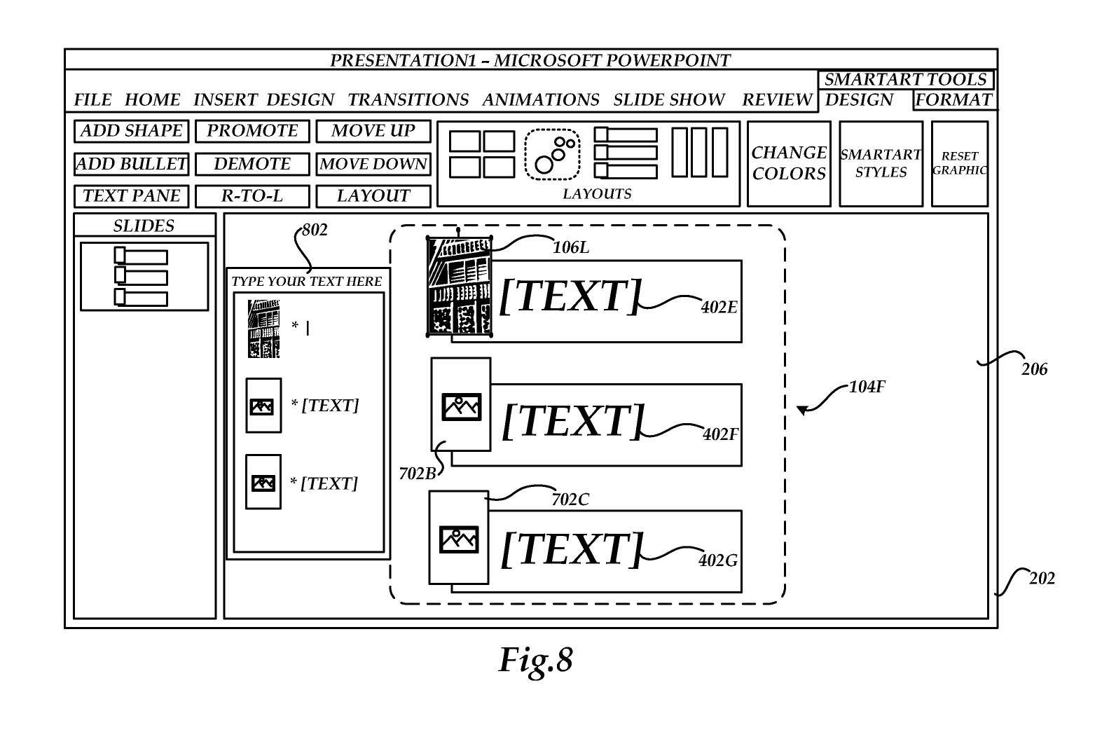

In the example shown in FIG. 7, the mouse cursor is utilized to select the image placeholder 702A. In response thereto, an appropriate user interface (not shown) may be presented through which a user can select an image to replace the placeholder 702A. Once the image has been selected, the image will be placed on the canvas 206 in place of the image placeholder 702A, as shown in FIG. 8.

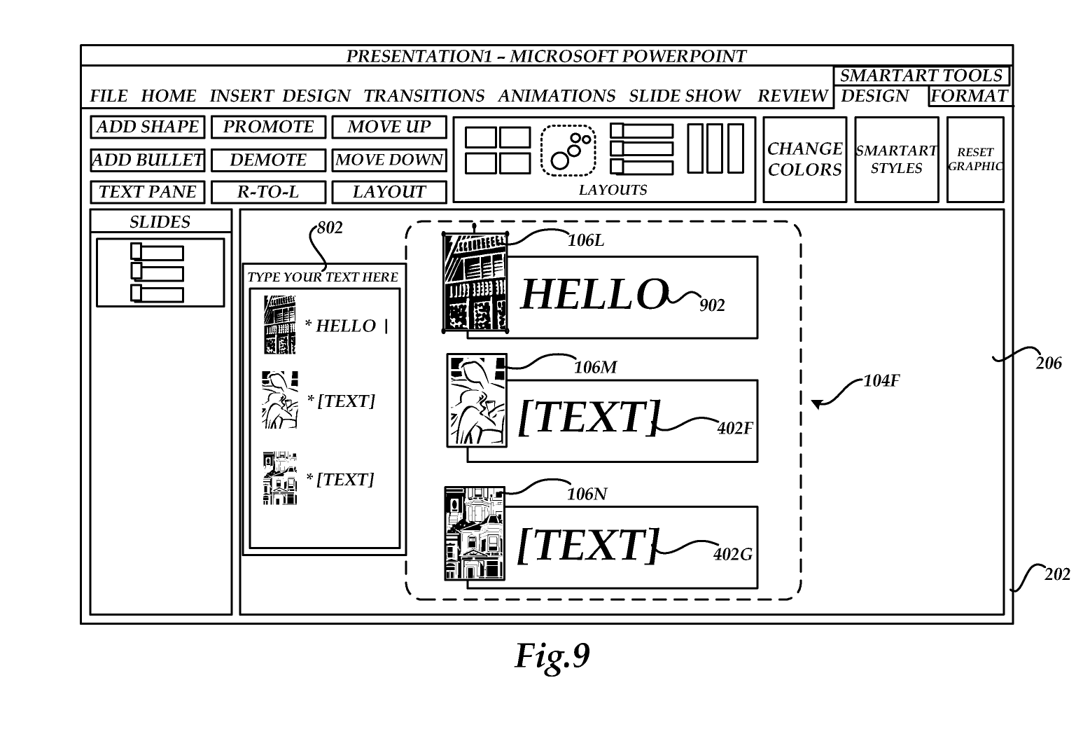

In one implementation, a user interface control 704 is also displayed adjacent to the layout 104F. When selected, the user interface control 704 will cause the text pane 802, illustrated in FIG. 8, to be displayed. As described briefly above, a user may also modify the placeholder text 402E-402G by selecting the placeholder text 402E-402G and typing or pasting new text. The typed text will replace the placeholder text. Alternately, the user may select the text in the text pane 802 and edit the text. The edited text will replace the corresponding text placeholder. For instance, in the example shown in FIGS. 8 and 9, the text pane 802 has been utilized to replace the text placeholder 402E with the text “hello.” It should be appreciated that the text placeholders 402F and 402G might be replaced in a similar fashion. Additionally, the image placeholders 702B and 702C have been replaced in FIG. 9 with the images 106M and 106N, respectively, utilizing the user interface mechanism described above with respect to FIGS. 7-8.

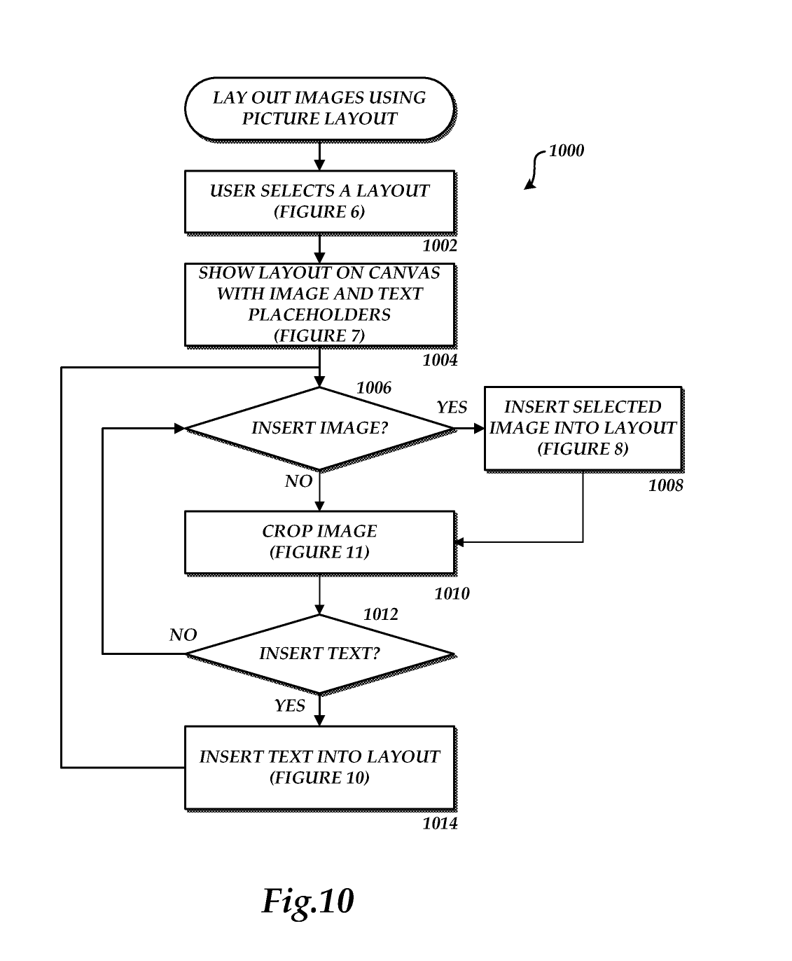

Referring now to FIG. 10, an illustrative routine 1000 will be described that illustrates the process presented above for laying out images using a pre-defined layout wherein the images have not been previously placed on the canvas 206. The routine 1000 begins at operation 1002, where a user selects a layout, such as in the manner described above with reference to FIG. 6. Once a layout has been selected, the routine 1000 proceeds to operation 1004, where the selected layout is shown on the canvas 206 by placing image placeholders 702 and text placeholders 402 at locations defined for the selected pre-defined layout in the layout definition file 102. This process is illustrated in FIG. 7.

Once the image placeholders 702 and the text placeholders 402 have been displayed on the canvas 206, the routine 1000 proceeds to operation 1006. At operation 1006, a determination is made as to whether a request has been made to replace one of the image placeholders 702 with an image. For instance, a user may select the image placeholder with an appropriate user input device to make such a request. In response to receiving such a request, the routine 1000 proceeds to operation 1008, where an image specified by the user is placed onto the canvas in place of the image placeholder as shown in FIG. 8. The routine 1000 then proceeds to operation 1010, where the image is cropped. An illustrative routine for cropping the image will be discussed below with respect to FIGS. 11 and 12.

From operation 1010, the routine 1000 proceeds to operation 1012, where a determination is made as to whether a user has requested to replace a text placeholder 402 with user-supplied text. If so, the routine 1000 proceeds to operation 1014, where the text is received and utilized to replace the text placeholder as shown in FIG. 10 and described above. From operation 1014, the routine 1000 proceeds to operation 1006, where additional images and text may be supplied.

Turning now to FIG. 11, an illustrative routine 1100 will be described that illustrates one process presented herein for cropping images in a layout in a manner that preserves the aspect ratio of the image. FIG. 11 will be described with reference to FIGS. 12A-12D. As known in the art, the aspect ratio of an image is the width of an image divided by the height of the image. For instance, the image 106P shown in FIG. 12A has an aspect ratio of 2.6:1. The destination shape 1200 shown in FIG. 12B has an aspect ratio of 1:1. The destination shape is the shape that is utilized to crop the image. Although the destination shape 1200 has been illustrated as a square in FIG. 12B, it should be appreciated that the destination shape 1200 may be any arbitrary shape.

The routine 1100 begins at operation 1102, where the application program 100 determines a percentage change for cropping the image to be cropped. The percentage change is the amount the image should be cropped expressed as a percentage of the size of a destination shape used to crop the image. In one embodiment, the percentage change is calculated by determining whether the aspect ratio of the image (referred to herein as the “source aspect ratio”) is greater than the aspect ratio of the destination shape (referred to herein as the “destination aspect ratio”). If the source aspect ratio is greater than the destination aspect ratio, then the percentage change is computed as (1−source aspect ratio/destination aspect ratio)/2*100. If the source aspect ratio is less than the destination aspect ratio, then the percentage change is computed as (1−destination aspect ratio/source aspect ratio)/2*100.

Once the percentage change has been computed at operation 1102, the routine 1100 proceeds to operation 1104, where the application program 100 determines which two sides of the image to crop. As shown in FIG. 12A, the image 106P has a top side 1202A, a bottom side 1202B, a left side 1202C, and a right side 1202D. In one embodiment, the application program 100 determines the sides 1202 to crop by determining whether the source aspect ratio is greater than the destination aspect ratio. If the source aspect ratio is greater than the destination aspect ratio, then the left side 1202C and the right side 1202D of the image are cropped. If the source aspect ratio is less than the destination aspect ratio, then the top side 1202A and the bottom side 1202B are cropped.

Once the sides of the image to be cropped have been determined, the routine 1100 proceeds from operation 1104 to operation 1106, where the identified sides of the image are cropped by the computed percentage change. For instance, in the example shown in FIGS. 12C-12D, the left side 1202C and the right side 1202D of the image 106P have been cropped using the destination shape 1200 by the computed percentage change (in this case, −80%), thereby resulting in the cropped image 1204. As shown in FIG. 12D, the resultant cropped image 1204 retains the same aspect ratio as the image 106P.

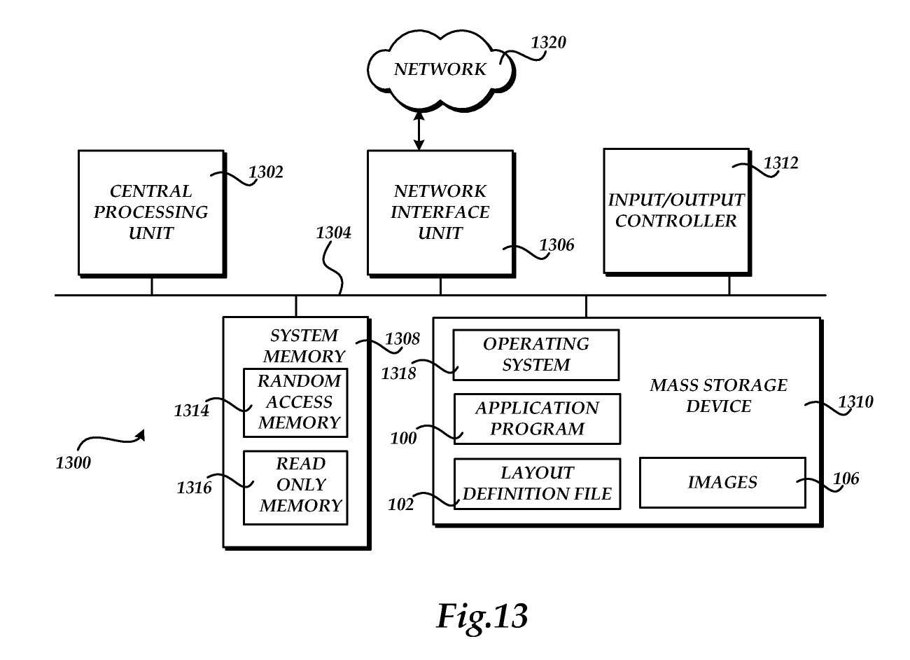

FIG. 13 shows an illustrative computer architecture for a computer 1300 capable of executing the software components described herein for laying out images and associated text annotations. The computer architecture shown in FIG. 13 illustrates a conventional desktop, laptop computer, or server computer and may be utilized to execute any aspects of the application program 100 described herein.

The computer architecture shown in FIG. 13 includes a central processing unit 1302 (“CPU”), a system memory 1308, including a random access memory 1314 (“RAM”) and a read-only memory (“ROM”) 1316, and a system bus 1304 that couples the memory to the CPU 1302. A basic input/output system containing the basic routines that help to transfer information between elements within the computer 1300, such as during startup, is stored in the ROM 1316. The computer 1300 further includes a mass storage device 1310 for storing an operating system 1318, application programs, and other program modules, which will be described in greater detail below.

The mass storage device 1310 is connected to the CPU 1302 through a mass storage controller (not shown) connected to the bus 1304. The mass storage device 1310 and its associated computer-readable media provide non-volatile storage for the computer 1300. Although the description of computer-readable media contained herein refers to a mass storage device, such as a hard disk or CD-ROM drive, it should be appreciated by those skilled in the art that computer-readable media can be any available computer storage media that can be accessed by the computer 1300.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 1300.

According to various embodiments, the computer 1300 may operate in a networked environment using logical connections to remote computers through a network such as the network 1320. The computer 1300 may connect to the network 1320 through a network interface unit 1306 connected to the bus 1304. It should be appreciated that the network interface unit 1306 may also be utilized to connect to other types of networks and remote computer systems. The computer 1300 may also include an input/output controller 1312 for receiving and processing input from a number of other devices, including a keyboard, mouse, or electronic stylus (not shown in FIG. 13). Similarly, an input/output controller may provide output to a display screen, a printer, or other type of output device (also not shown in FIG. 13).

As mentioned briefly above, a number of program modules and data files may be stored in the mass storage device 1310 and RAM 1314 of the computer 1300, including an operating system 1318 suitable for controlling the operation of a networked desktop, laptop, or server computer. The mass storage device 1310 and RAM 1314 may also store one or more program modules. In particular, the mass storage device 1310 and the RAM 1314 may store an application program 100 that provides the functionality described herein for dynamically laying out images and associated text using pre-defined layouts and for cropping images for use in a layout. The mass storage device 1310 and RAM 1314 may also store the layout definition file 102 and the images 106 utilized by the application program 100.

In general, software applications or modules may, when loaded into the CPU 1302 and executed, transform the CPU 1302 and the overall computer 1300 from a general-purpose computing system into a special-purpose computing system customized to perform the functionality presented herein. The CPU 1302 may be constructed from any number of transistors or other discrete circuit elements, which may individually or collectively assume any number of states. More specifically, the CPU 1302 may operate as one or more finite-state machines, in response to executable instructions contained within the software or modules. These computer-executable instructions may transform the CPU 1302 by specifying how the CPU 1302 transitions between states, thereby physically transforming the transistors or other discrete hardware elements constituting the CPU 1302.

Encoding the software or modules onto a mass storage device may also transform the physical structure of the mass storage device or associated computer readable storage media. The specific transformation of physical structure may depend on various factors, in different implementations of this description. Examples of such factors may include, but are not limited to: the technology used to implement the computer readable storage media, whether the computer readable storage media are characterized as primary or secondary storage, and the like. For example, if the computer readable storage media is implemented as semiconductor-based memory, the software or modules may transform the physical state of the semiconductor memory, when the software is encoded therein. For example, the software may transform the states of transistors, capacitors, or other discrete circuit elements constituting the semiconductor memory.

As another example, the computer readable storage media may be implemented using magnetic or optical technology. In such implementations, the software or modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

Based on the foregoing, it should be appreciated that technologies for cropping and laying out images and associated text are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for dynamically laying out one or more images according to one or more pre-defined layouts, the method comprising:
displaying a canvas for presenting the layout;
displaying representations of the one or more pre-defined layouts;
receiving a selection of one of the representations;
in response to receiving the selection of one of the representations, displaying selectable image placeholders on the canvas for the one or more images, each image placeholder having a location defined by the pre-defined layout associated with the selected representation;
receiving a request to place an image on the canvas in place of an image placeholder; and
in response to the request, placing the image on the canvas in place of the image placeholder.

2. The computer-implemented method of claim 1, further comprising in response to receiving the selection of one of the representations:
displaying selectable text placeholders on the canvas for text associated with the one or more images, each text placeholder having a location defined by the pre-defined layout associated with the selected representation;
receiving a request to replace a text placeholder with text; and
in response to the request, replacing the text placeholder with the text.

4. The computer-implemented method of claim 1, further comprising in response to receiving the request to place an image on the canvas in place of a placeholder: cropping the image prior to placing the image on the canvas in place of the placeholder.

5. The computer-implemented method of claim 4, wherein cropping the image comprises:
determining a percentage change for cropping the image, the percentage change comprising the amount the image should be cropped expressed as a percentage of the size of a destination shape used to crop the image;
determining two sides of the image to crop; and
cropping the identified sides of the image by the determined percentage change.

6. The computer-implemented method of claim 5, wherein determining the percentage change for cropping the image comprises determining whether an aspect ratio (source aspect ratio) of the image is greater than an aspect ratio (destination aspect ratio) of the destination shape and, if the aspect ratio of the image is greater than the aspect ratio of the destination shape, then computing the percentage change as (1−source aspect ratio/destination aspect ratio)/2*100.

7. The computer-implemented method of claim 5, wherein determining the percentage change for cropping the image comprises determining whether an aspect ratio (source aspect ratio) of the image is greater than an aspect ratio (destination aspect ratio) of the destination shape and, if the aspect ratio of the image is less than the aspect ratio of the destination shape, then computing the percentage change as (1−destination aspect ratio/source aspect ratio)/2*100.

8. The computer-implemented method of claim 5, wherein determining two sides of the image to crop comprises determining whether an aspect ratio (source aspect ratio) of the image is greater than an aspect ratio (destination aspect ratio) of the destination shape and, if the aspect ratio of the image is less than the aspect ratio of the destination shape, then determining that the two sides of the image to crop are a top side of the image and a bottom side of the image.

9. The computer-implemented method of claim 5, wherein determining two sides of the image to crop comprises determining whether an aspect ratio (source aspect ratio) of the image is greater than an aspect ratio (destination aspect ratio) of the destination shape and, if the aspect ratio of the image is greater than the aspect ratio of the destination shape, then determining that the two sides of the image to crop are a left side of the image and a right side of the image.

10. A computer-implemented method for cropping an image, the method comprising:
determining a percentage change for cropping the image, the percentage change comprising the amount the image should be cropped expressed as a percentage of the size of a destination shape used to crop the image;
determining two sides of the image to crop; and
cropping the identified sides of the image by the determined percentage change.

11. The computer-implemented method of claim 10, wherein determining the percentage change for cropping the image comprises determining whether an aspect ratio (source aspect ratio) of the image is greater than an aspect ratio (destination aspect ratio) of the destination shape and, if the aspect ratio of the image is greater than the aspect ratio of the destination shape, then computing the percentage change as (1−source aspect ratio/destination aspect ratio)/2*100.

12. The computer-implemented method of claim 11, wherein determining the percentage change for cropping the image comprises determining whether an aspect ratio (source aspect ratio) of the image is greater than an aspect ratio (destination aspect ratio) of the destination shape and, if the aspect ratio of the image is less than the aspect ratio of the destination shape, then computing the percentage change as (1−destination aspect ratio/source aspect ratio)/2*100.

13. The computer-implemented method of claim 10, wherein determining two sides of the image to crop comprises determining whether an aspect ratio (source aspect ratio) of the image is greater than an aspect ratio (destination aspect ratio) of the destination shape and, if the aspect ratio of the image is less than the aspect ratio of the destination shape, then determining that the two sides of the image to crop are a top side of the image and a bottom side of the image.

14. The computer-implemented method of claim 13, wherein determining two sides of the image to crop comprises determining whether an aspect ratio (source aspect ratio) of the image is greater than an aspect ratio (destination aspect ratio) of the destination shape and, if the aspect ratio of the image is greater than the aspect ratio of the destination shape, then determining that the two sides of the image to crop are a left side of the image and a right side of the image.

15. A computer-readable medium having computer-executable instructions stored thereupon which, when executed by a computer, cause the computer to:
display representations of one or more pre-defined layouts, receive a selection of one of the representations, display selectable image placeholders on a canvas for the one or more images in response to receiving the selection of one of the representations, receive a request to place an image on the canvas in place of an image placeholder, and placing the image on the canvas in place of the image placeholder in response to the request; and
receive the placement of one or more images on the canvas, display a layout gallery adjacent to the canvas comprising selectable representations of the one or more pre-defined layouts, receive a selection of one of the representations in the layout gallery, and in response to the selection, dynamically generating a layout for the one or more images based on a pre-defined layout corresponding to the selected representation, and displaying the layout on the canvas.

16. The computer-readable medium of claim 15, having further computer-executable instructions stored thereupon which, when executed by the computer, will cause the computer to crop an image prior to placing the image on the canvas by determining a percentage change for cropping the image, determining two sides of the image to crop, and cropping the identified sides of the image by the determined percentage change, wherein the percentage change comprises the amount the image should be cropped expressed as a percentage of the size of a destination shape used to crop the image.

17. The computer-readable medium of claim 16, wherein determining the percentage change for cropping the image comprises determining whether an aspect ratio (source aspect ratio) of the image is greater than an aspect ratio (destination aspect ratio) of the destination shape and, if the aspect ratio of the image is greater than the aspect ratio of the destination shape, then computing the percentage change as (1−source aspect ratio/destination aspect ratio)/2*100.

18. The computer-readable medium of claim 17, wherein determining the percentage change for cropping the image comprises determining whether an aspect ratio (source aspect ratio) of the image is greater than an aspect ratio (destination aspect ratio) of the destination shape and, if the aspect ratio of the image is less than the aspect ratio of the destination shape, then computing the percentage change as (1−destination aspect ratio/source aspect ratio)/2*100.

19. The computer-readable medium of claim 18, wherein determining two sides of the image to crop comprises determining whether an aspect ratio (source aspect ratio) of the image is greater than an aspect ratio (destination aspect ratio) of the destination shape and, if the aspect ratio of the image is less than the aspect ratio of the destination shape, then determining that the two sides of the image to crop are a top side of the image and a bottom side of the image.

20. The computer-readable medium of claim 19, wherein determining two sides of the image to crop comprises determining whether an aspect ratio (source aspect ratio) of the image is greater than an aspect ratio (destination aspect ratio) of the destination shape and, if the aspect ratio of the image is greater than the aspect ratio of the destination shape, then determining that the two sides of the image to crop are a left side of the image and a right side of the image.
